(19) United States
(12) Patent Application Publication
(10) Pub. No.: US 2025/0371629 A1
(43) Pub. Date: Dec. 4, 2025

(54) Hierarchical and Graded Source-Network-Load-Storage Multi-Subject Collaborative Scheduling Method

(71) Applicant: Guizhou Power Grid Co., Ltd., Guiyang (CN)

(72) Inventors: Xin HE, Guiyang (CN); Yu ZHANG, Guiyang (CN); Xueyong TANG, Guiyang (CN); Julong CHEN, Guiyang (CN); Qingsheng LI, Guiyang (CN); Zhen LI, Guiyang (CN); Zhaofeng ZHANG, Guiyang (CN); Libo ZHANG, Guiyang (CN); Bin WANG, Guiyang (CN); Chen LUO, Guiyang (CN)

(21) Appl. No.: 19/006,910

(22) Filed: Dec. 31, 2024

Related U.S. Application Data
(63) Continuation of application No. PCT/CN2024/135936, filed on Nov. 29, 2024.

(30) Foreign Application Priority Data
May 30, 2024 (CN) 2024106869404

(51) Int. Cl. G06Q 50/06; G06Q 10/0631

(52) U.S. Cl. CPC G06Q 50/06; G06Q 10/06314

(57) ABSTRACT

The present invention discloses a hierarchical and graded source-network-load-storage multi-subject collaborative scheduling method and system, and relates to the technical field of new energy. The method includes: obtaining power supply data, obtaining electricity consumption data corresponding to each level of an urban area, and obtaining energy storage data of electricity storage devices; obtaining historical data sets, and analyzing the power supply data, the electricity consumption data, and the energy storage data to obtain estimated electric energy data; and calling the electricity storage devices in surrounding regions according to the adjusted secondary electricity consumption data of the urban area. The present invention may optimize and schedule on sources, networks, loads, and storage.

### CROSS-REFERENCE TO RELATED APPLICATIONS

The present application claims priority to Chinese Patent Application No. 2024106869404, filed on May 30, 2024, the entire disclosure of which is incorporated herein by reference.

### TECHNICAL FIELD

The present invention relates to the technical field of new energy, and specifically relates to a hierarchical and graded source-network-load-storage multi-subject collaborative scheduling method and system.

### BACKGROUND

In recent years, with increasingly severe global energy crisis and environmental pollution problems, a hierarchical and graded source-network-load-storage multi-subject collaborative scheduling technology (hereinafter referred to as a multi-subject collaborative scheduling technology) has become an important direction for modernization transformation of an electric power system. This technology aims to realize optimal configuration for energy supply and increase for running efficiency through efficiently integrating and optimizing various diversified resources such as power supplies, power grids, electricity consumption loads, and energy storage devices.

In a traditional electric power system, generation, transmission, distribution, use, and other links for electric energy are often operated independently, and the manner lacks systematic optimization and cannot adapt well to volatility and uncertainty of renewable energy such as wind electricity and photovoltaics. With development of a smart power grid technology, a demand for integrating multi-source coordination and multi-level energy management is increasing, especially in a context of large-scale access for the renewable energy and rapid increase of new loads such as electric vehicles.

The multi-subject collaborative scheduling technology realizes comprehensive analysis and efficient utilization for power supply data, electricity consumption data, and energy storage data through collaborative work of a data obtaining module, a data processing module, a primary electricity supply adjustment module, and a secondary electricity supply adjustment module. Through the method, real-time monitoring and adjustment are carried out on power supplies by means of environment data (such as illumination intensity, a wind speed, etc.) and power data (including an active power and a reactive power), and meanwhile, a dynamic balance is carried out according to electricity consumption demands of different urban area levels (such as a special level, a residential level, and industrial and commercial levels).

### SUMMARY

In view of the above existing problems, the present invention is proposed.

Therefore, the technical problem solved by the present invention is: the problem of unreasonable distribution for regional electric power.

In order to solve the above technical problem, the present invention provides the following technical solution: a hierarchical and graded source-network-load-storage multi-subject collaborative scheduling method includes the following steps:
obtaining environment data, power data, and electricity generation data of electricity generation stations to obtain power supply data, obtaining electricity consumption data corresponding to different levels of an urban area, and obtaining energy storage data of electricity storage devices through a data obtaining module; obtaining historical data sets of the electricity generation stations, the urban area, and the electricity storage devices, and analyzing the power supply data, the electricity consumption data, and the energy storage data according to the historical data sets to obtain estimated electric energy data through a data processing module; adjusting electric energy supply of the electricity generation stations, the urban area, and the electricity storage devices according to the estimated electric energy data, and monitoring the electricity consumption data of the different levels of the urban area after being adjusted to obtain secondary electricity consumption data through a primary electricity supply adjustment module; and calling the electricity storage devices in surrounding regions according to the secondary electricity consumption data to supplement electric energy through a secondary electricity supply adjustment module.

As a preferred solution for the hierarchical and graded source-network-load-storage multi-subject collaborative scheduling method of the present invention, where: the obtaining power supply data includes that a data obtaining module is associated with illumination sensors and photovoltaic electricity generation devices of a photovoltaic electricity generation station to obtain illumination intensity, a photovoltaic electricity generation quantity, a photovoltaic active power, and a photovoltaic reactive power of the photovoltaic electricity generation station.

The data obtaining module is associated with wind speed sensors and wind electricity generation devices of a wind electricity generation station to obtain a wind speed, a wind electricity generation quantity, a wind active power, and a wind reactive power of the wind electricity generation station.

The data obtaining module is associated with a power grid of the urban area to obtain an electricity consumption quantity of a special level, an electricity consumption quantity of a residential level, and an electricity consumption quantity of industrial and commercial levels, so as to obtain electricity consumption data.

The data obtaining module is associated with electricity storage devices to obtain device types and stored electric quantities of the electricity storage devices, so as to obtain energy storage data.

The data obtaining module takes the illumination intensity and the wind speed as environment data, takes the wind active power, the wind reactive power, the photovoltaic active power, and the photovoltaic reactive power as power data, takes the wind electricity quantity and the photovoltaic electricity generation quantity as electricity generation data, and takes the environment data, the power data and the electricity generation data as power supply data.

the data obtaining module sends the power supply data, the electricity consumption data, and the energy storage data to the data processing module.

As a preferred solution for the hierarchical and graded source-network-load-storage multi-subject collaborative scheduling method of the present invention, where: the obtaining historical data sets of the electricity generation stations, the urban area, and the electricity storage devices includes that the data processing module obtains historical average data of the electricity generation stations, the urban area, and the electricity storage devices in the past three years, and historical average data of an environment through a database, so as to obtain historical data sets.

average values of the historical data sets are calculated respectively, variances of the historical data sets are calculated respectively after the average values are evaluated, standard deviations of the historical data sets are calculated respectively after the variances are evaluated, and covariances of the historical data sets are calculated respectively after the standard deviations are evaluated through the data processing module.

As a preferred solution for the hierarchical and graded source-network-load-storage multi-subject collaborative scheduling method of the present invention, where: the obtaining estimated electric energy data includes that correlation coefficients in the historical data sets are calculated respectively, regression coefficients in the historical data sets are calculated respectively after the correlation coefficients are evaluated, correction coefficients in the historical data sets are calculated respectively after the regression coefficients are evaluated to obtain regression equations, and estimated electric energy data is calculated after the regression equations are obtained through the data processing module, and the estimated electric energy data is sent to a primary electricity supply adjustment module through the data processing module after the estimated electric energy data is obtained.

As a preferred solution for the hierarchical and graded source-network-load-storage multi-subject collaborative scheduling method of the present invention, where: the adjusting electric energy supply of the electricity generation stations, the urban area, and the electricity storage devices includes that the primary electricity supply adjustment module records the photovoltaic reactive power in the power supply data as nip, and records the wind reactive power as nwp.

The electricity consumption quantity of the special level in the electricity consumption data is recorded as Ua, the electricity consumption quantity of the residential level is recorded as Ub, and the electricity consumption quantity of the industrial and commercial levels is recorded as Uc.

Device types in the energy storage data are read, and the stored electric quantities are recorded as s.

Comparing the stored electric quantities through the primary electricity supply adjustment module includes that if s≥(msi+msw), it indicates that an energy supply relationship does not need to be adjusted, if s≤(msi+msw), it indicates that an electric power demand is increased, when s<(msi+msw), if s−(Ua+Ub+Uc)>0, it indicates that the, energy supply relationship does not need to be adjusted, if s−(Ua+Ub+Uc)<0 it indicates that electric power needs to be supplemented additionally, if s−(Ua+Ub+Uc)=0, it indicates that the electric power demand is increased, and when s−(Ua+Ub+Uc)=0 the primary electricity supply adjustment module compares a useful power and adjusts the electricity generation stations, and the primary electricity supply adjustment module compares useful electricity data and adjusts electric power distribution.

wherein msi represents the stored electric quantity of an estimated photovoltaic electricity generation quantity, msw represents the stored electric quantity of the wind electricity generation quantity, Ua represents the electricity consumption quantity of the special level in the electricity consumption data, Ub represents the electricity consumption quantity of the residential level, and Uc represents the electricity consumption quantity of the industrial and commercial levels.

As a preferred solution for the hierarchical and graded source-network-load-storage multi-subject collaborative scheduling method of the present invention, where: the obtaining secondary electricity consumption data includes that after the electric energy supply adjustment for the electricity generation stations, the urban area, and the electricity storage devices is completed, the primary electricity supply adjustment module obtains the electricity consumption data of the different levels again, and records the electricity consumption data as Uaa, Ubb, and Ucc.

the calculating secondary electricity consumption data through the primary electricity supply adjustment module is represented as

$$Δ UU = ( mUi + mUw ) - ( Uaa + Ubb + Ucc )$$

where mUi represents the estimated photovoltaic electricity generation quantity, and mUw represents an estimated wind electricity generation quantity.

the primary electricity supply adjustment module sends the secondary electricity consumption data to a secondary electricity supply adjustment module.

As a preferred solution for the hierarchical and graded source-network-load-storage multi-subject collaborative scheduling method of the present invention, where: the calling the electricity storage devices in surrounding regions to supplement electric energy includes that whether the secondary electricity consumption data ΔUU is greater than 0 or not is judged through the secondary electricity supply adjustment module, if 0, it indicates that electric energy supply is balanced, and if <0, it indicates that electric power needs to be supplemented additionally from the electricity storage devices in surrounding regions.

Another purpose of the present invention is to provide a hierarchical and graded source-network-load-storage multi-subject collaborative scheduling system, and the hierarchical and graded source-network-load-storage multi-subject collaborative scheduling system can carry out real-time monitoring and dynamic scheduling on electric energy resources through intelligent data processing and optimization algorithms, so that the problems of uneven allocation for existing electric energy resources, low energy efficiency, and response time delay are solved.

In order to solve the above technical problems, the present invention provides the following technical solution: a hierarchical and graded source-network-load-storage multi-subject collaborative scheduling system includes a data obtaining module, a data processing module, a primary electricity supply adjustment module, a secondary electricity supply adjustment module, and a database module.

The data obtaining module is used for obtaining environment data, power data, and electricity generation data of electricity generation stations to obtain power supply data, obtaining electricity consumption data corresponding to different levels of an urban area, and obtaining energy storage data of electricity storage devices.

The data processing module is used for obtaining historical data sets of the electricity generation stations, the urban area, and the electricity storage devices, and analyzing the power supply data, the electricity consumption data, and the energy storage data according to the historical data sets to obtain estimated electric energy data.

The primary electricity supply adjustment module is used for adjusting electric energy supply of the electricity generation stations, the urban area, and the electricity storage devices according to the estimated electric energy data, and monitoring the electricity consumption data of the different levels of the urban area after being adjusted to obtain secondary electricity consumption data.

The secondary electricity supply adjustment module is used for calling the electricity storage devices in surrounding regions according to the secondary electricity consumption data to supplement electric energy.

the database module is used for storing historical average data of the electricity generation stations, the urban area, and the electricity storage device, historical average data of an environment, illumination time periods of different regions, the maximum stored electricity quantity of the different electricity storage devices, the maximum photoelectric inversion coefficient, and the maximum wind electricity inversion coefficient.

A computer device includes a memory and a processor, where the memory stores a computer program, and when the processor executes the computer program, the steps of the above-mentioned hierarchical and graded source-network-load-storage multi-subject collaborative scheduling method are realized.

A computer-readable storage medium in which a computer program is stored, where when the computer program is executed by a processor, the steps of the above-mentioned hierarchical and graded source-network-load-storage multi-subject collaborative scheduling method are realized.

The beneficial effects of the present invention are that: according to the present invention, collaborative scheduling among sources, grids, loads, and storage can be realized through fully utilizing participation of a plurality of types of energy and a plurality of subjects, so that running efficiency of an electric power system is increased; according to the present invention, a balance of energy supply and demand is enabled to be more reasonable through carrying out overall optimized scheduling on different sources, networks, loads, and storage, so that an optimal energy configuration and scheduling strategy is realized; according to the hierarchical and graded source-network-load-storage multi-subject collaborative scheduling method, volatility and uncertainty of renewable energy can be fully considered, smooth consumption-absorption is realized through energy storage and other means, so that utilization efficiency for the renewable energy is increased and consumption-absorption capability for the renewable energy is improved; and with regard to different energy departments and users, according to the invention, scheduling and running costs for the electric power system can be reduced through collaborative scheduling, demand-side response, and other strategies.

### BRIEF DESCRIPTION OF DRAWINGS

In order to describe the technical solutions in the examples of the present invention more clearly, a brief description for the drawings needing to be used in the description for the examples will be provided below, apparently, the drawings in the description below show merely some examples of the present invention, and those of ordinary skill in the art may also derive other drawings from these drawings without making creative efforts.

FIG. 1 is an overall flow diagram of a hierarchical and graded source-network-load-storage multi-subject collaborative scheduling method which is provided by a first example of the present invention; and

FIG. 2 is an overall framework diagram of a hierarchical and graded source-network-load-storage multi-subject collaborative scheduling system which is provided by a second example of the present invention.

### DETAILED DESCRIPTION OF THE EMBODIMENTS

In order to make the above purposes, features, and advantages of the present invention more apparent and understandable, the specific implementation manners of the present invention are described below in detail in conjunction with the drawings of the present invention, and apparently, the examples described are merely a part rather than all of the examples of the present invention. On the basis of the examples of the present invention, all other examples obtained by those of ordinary skill in the art without creative efforts shall fall within the protection scope of the present invention.

### Example 1

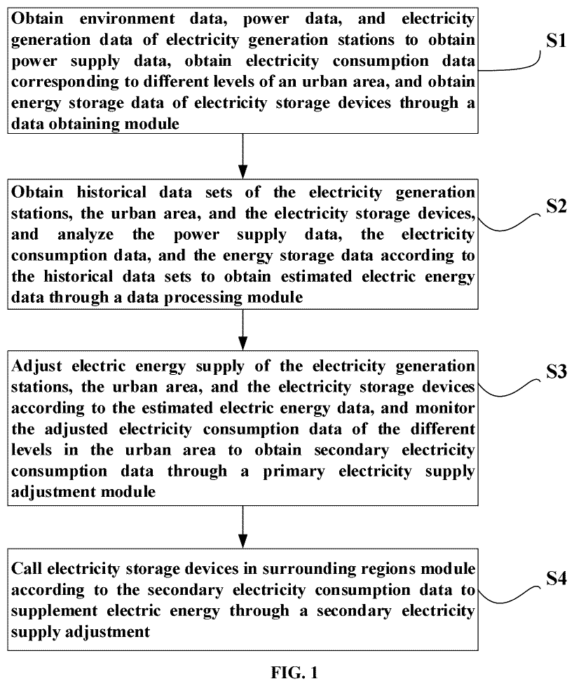

Referring to FIG. 1, an example of the present invention is proposed, and provides a hierarchical and graded source-network-load-storage multi-subject collaborative scheduling method, including:

S1: obtaining environment data, power data, and electricity generation data of electricity generation stations to obtain power supply data, obtaining electricity consumption data corresponding to different levels of an urban area, and obtaining energy storage data of electricity storage devices through a data obtaining module.

Further, a working flow of the data obtaining module is as follows:
the data obtaining module is associated with illumination sensors and photovoltaic electricity generation devices of a photovoltaic electricity generation station to obtain illumination intensity, a photovoltaic electricity generation quantity, a photovoltaic active power, and a photovoltaic reactive power of the photovoltaic electricity generation station.

The data obtaining module is associated with wind speed sensors and wind electricity generation devices of a wind electricity generation station to obtain a wind speed, a wind electricity generation quantity, a wind active power, and a wind reactive power of the wind electricity generation station.

The data obtaining module is associated with a power grid of the urban area to obtain an electricity consumption quantity of a special level, an electricity consumption quantity of a residential level, and an electricity consumption quantity of industrial and commercial levels, so as to obtain electricity consumption data.

The data obtaining module is associated with electricity storage devices to obtain device types and stored electric quantities of the electricity storage devices, so as to obtain energy storage data.

The data obtaining module takes the illumination intensity and the wind speed as environment data, takes the wind active power, the wind reactive power, the photovoltaic active power, and the photovoltaic reactive power as power data, takes the wind electricity generation quantity and the photovoltaic electricity generation quantity as electricity generation data, and takes the environment data, the power data and the electricity generation data as power supply data.

the data obtaining module sends the power supply data, the electricity consumption data, and the energy storage data to the data processing module.

S2: obtaining historical data sets of the electricity generation stations, the urban area, and the electricity storage devices, and analyzing the power supply data, the electricity consumption data, and the energy storage data according to the historical data sets to obtain estimated electric energy data through a data processing module.

Furthermore, a working flow of the data processing module is as follows:

a flow A1: the data processing module records illumination intensity in the environment data as i, records the wind speed as w, records the photovoltaic active power as uip, records the wind active power as uwp, records the photovoltaic electricity generation quantity as iw, and records the wind electricity generation quantity as ww.

A flow A2: the data processing module obtains historical average data of the electricity generation stations, the urban area, and the electricity storage devices in the past three years, and historical average data of an environment through a database, so as to obtain historical data sets.

Historical data of the electricity generation stations includes:
historical average photovoltaic active powers uip1, uip2, and uip3.

Historical average photovoltaic electricity generation quantities iw1, iw2, and iw3.

Historical average wind active powers uwp1, uwp2, and uwp3.

Historical average wind electricity generation quantities ww1, ww2, and ww3.

Historical data of the urban area:
historical average electricity consumption quantities Ua1, Ua2, and Ua3 of the special level.

Historical average electricity consumption quantities Ub1, Ub2, and Ub3 of the residential level.

Historical average electricity consumption quantities Uc1, Uc2, and Uc3 of the industrial and commercial levels.

Historical data of the electricity storage devices: historical average stored electricity quantities s1, s2, and s3.

Historical average data of the environment:
historical average illumination intensity i1, i2, and i3.

Historical average wind speeds w1, w2, and w3.

A flow A3: the data processing module calculates average values of the historical data sets respectively.

Average values of the historical data of the electricity generation stations:
an average value Δuip of historical photovoltaic active powers, an average value Δiw of historical photovoltaic electricity generation quantities, an average value Δuwp of historical wind active powers, and a historical wind electricity generation quantity Δww.

Average values of the historical data of the urban area:
an average value ΔUa of historical electricity consumption quantities of the special level, an average value ΔUb of historical electricity consumption quantities of the residential level, and an average value & Uc of historical electricity consumption quantities of the industrial and commercial levels.

An average value of the historical data of the electricity storage devices: an average value Δs of historical stored electricity quantities.

Average values of the historical data of an environment: an average value Δi of historical illumination intensity, and an average value Δw of historical wind speeds.

A flow A4: the data processing module calculates variances of the historical data sets respectively.

(1) Variances of the historical data of the electricity generation stations:
a variance vuip of the historical photovoltaic active powers:

$$vuip = \sqrt{\frac{1}{3} {\sum }_{n = 1}^{3} ( u i p n - Δ uip )}$$

a variance viw of the historical photovoltaic electricity generation quantities:

$$viw = \sqrt{\frac{1}{3} {\sum }_{n = 1}^{3} ( iwn - Δ iw )}$$

a variance vuwp of the historical wind active powers:

$$vuwp = \sqrt{\frac{1}{3} {\sum }_{n = 1}^{3} ( uwpn - Δ uwp )}$$

a variance vww of the historical wind electricity generation quantities:

$$v w w = \sqrt{\frac{1}{3} {\sum }_{n = 1}^{3} ( w w n - Δ w w )}$$

(2) variances of the historical data of the urban area:
a variance vUa of the historical electricity consumption quantities of the special level:

$$vUa = \sqrt{\frac{1}{3} {\sum }_{n = 1}^{3} ( U a n - Δ Ua )}$$

a variance vUb of the historical electricity consumption quantities of the residential level:

$$v U b = \sqrt{\frac{1}{3} {\sum }_{n = 1}^{3} ( U b n - Δ Ub )}$$

a variance vUc of the historical electricity consumption quantities of the industrial and commercial levels:

$$v U c = \sqrt{\frac{1}{3} {\sum }_{n = 1}^{3} ( U c n - Δ Uc )}$$

(3) a variance of the historical data of the electricity storage devices:
a variance vs of historical stored electricity quantities:

$$vs = \sqrt{\frac{1}{3} {\sum }_{n = 1}^{3} ( s n - Δ s )}$$

(4) variances of the historical data of the environment:
a variance vi of the historical illumination intensity:

$$v i = \sqrt{\frac{1}{3} {\sum }_{n = 1}^{3} ( i n - Δ i )}$$

a variance vw of the historical wind speeds:

$$v w = \sqrt{\frac{1}{3} {\sum }_{n = 1}^{3} ( w n - Δ w )}$$

A flow A5: the data processing module calculates standard deviations of the historical data sets respectively.

(1) Standard deviations of the historical data of the electricity generation stations:
a standard deviation sduip of the historical photovoltaic active powers:

$$sduip = {( vuip )}^{2}$$

a standard deviation sdiw of the historical photovoltaic electricity generation quantities:

$$sdiw = {( viw )}^{2}$$

a standard deviation sduwp of the historical wind active powers:

$$sduwp = {( vuwp )}^{2}$$

a standard deviation sdww of the historical wind electricity generation quantities:

$$sdww = {( vww )}^{2}$$

(2) standard deviations of the historical data of the urban area:
a standard deviation sdUa of the historical electricity consumption quantities of the special level:

$$s d U a = {( vUa )}^{2}$$

a standard deviation sdUb of the historical electricity consumption quantities of the residential level:

$$sdUb = {( vUb )}^{2}$$

a standard deviation sdUc of the historical electricity consumption quantities of the industrial and commercial levels:

$$sdUc = {( vUc )}^{2}$$

(3) a standard deviation of the historical data of the electricity storage devices:
a standard deviation sds of the historical stored electricity quantities:

$$s d s = {( v s )}^{2}$$

(4) standard deviations of the historical data of the environment:
a standard deviation sdi of the historical illumination intensity:

$$s d i = {( v i )}^{2}$$

a standard deviation sdw of the historical wind speeds:

$$s d w = {( v w )}^{2}$$

A flow A5: the data processing module calculates covariances in the historical data sets respectively.

A flow A51: a covariance ci1 of the illumination intensity with respect to the photovoltaic active power, and a covariance cw1 of the wind speed with respect to the wind active power are calculated.

$$ci 1 = \frac{1}{2} ( {\sum }_{n = 1}^{3} ( i n - Δ i ) * ( uipn - Δ uip ) )$$

$$cw 1 = \frac{1}{2} ( {\sum }_{n = 1}^{3} ( w n - Δ w ) * ( uwpn - Δ uwp ) )$$

A flow A52: a covariance ci2 of the photovoltaic active power with respect to the photovoltaic electricity generation quantity, and a covariance cw2 of the wind active power with respect to the wind electricity generation quantity are calculated.

$$ci 2 = \frac{1}{2} ( {\sum }_{n = 1}^{3} ( uipn - Δ uip ) * ( i w n - Δ iw ) )$$

$$cw 2 = \frac{1}{2} ( {\sum }_{n = 1}^{3} ( uwpn - Δ uwp ) * ( w w n - Δ ww ) )$$

A flow A53: covariances cia3, cib3, and cic3 of the photovoltaic electricity generation quantity with respect to electricity consumption of the special level, the residential level, and the industrial and commercial levels are calculated respectively.

$$cia 3 = \frac{1}{4} ( {\sum }_{n = 1}^{3} ( i w n - Δ iw ) * ( Ucn - Δ Uc ) )$$

$$cib 3 = \frac{1}{4} ( {\sum }_{n = 1}^{3} ( i w n - Δ iw ) * ( Ubn - Δ Ub ) )$$

$$cic 3 = \frac{1}{4} ( {\sum }_{n = 1}^{3} ( i w n - Δ iw ) * ( Ucn - Δ Uc ) )$$

A flow A54: covariances cwa3, cwb3, and cwc3 of the wind electricity generation quantity with respect to the electricity consumption of the special level, the residential level, and the industrial and commercial levels are calculated respectively.

$$cwa 3 = \frac{1}{4} ( {\sum }_{n = 1}^{3} ( w w n - Δ ww ) * ( Uan - Δ Ua ) )$$

$$cwb 3 = \frac{1}{4} ( {\sum }_{n = 1}^{3} ( w w n - Δ ww ) * ( Ubn - Δ Ub ) )$$

$$cwc 3 = \frac{1}{4} ( {\sum }_{n = 1}^{3} ( w w n - Δ ww ) * ( Ucn - Δ Uc ) )$$

A flow A55: a covariance ci4 of the photovoltaic electricity generation quantity with respect to the stored electricity quantity is calculated; and a covariance cw4 of the wind electricity generation quantity with respect to the stored electricity quantity is calculated.

$$ci 4 = \frac{1}{4} ( {\sum }_{n = 1}^{3} ( w i n - Δ iw ) * ( s n - Δ s ) )$$

$$cw 4 = \frac{1}{4} ( {\sum }_{n = 1}^{3} ( w w n - Δ ww ) * ( s n - Δ s ) )$$

A flow A6: the data processing module calculates correlation coefficients in the historical data sets respectively.

A flow A61: a correlation coefficient ri1 of the illumination intensity with respect to the photovoltaic active power is calculated, where ri1=ci1/(sdi*sduip).

A correlation coefficient rw1 of the wind speed with respect to the wind active power is calculated, where rw1=cw1/(sdw*sduwp).

A flow A62: a correlation coefficient ri2 of the photovoltaic active power with respect to the photovoltaic electricity generation quantity is calculated, where ri2=ci2/(sduip*sdiw).

A correlation coefficient rw2 of the wind active power with respect to the wind electricity generation quantity is calculated, where rw2=cw2/(sduwp*sdww).

A flow A63: correlation coefficients ria3, rib3, and ric3 of the photovoltaic electricity generation quantity with respect to the electricity consumption of the special level, the residential level, and the industrial and commercial levels are calculated respectively.

$$ria 3 = 0.5 * cia 3 / ( sdiw * sdUa ) .$$

$$rib 3 = 0.5 * cib 3 / ( sdiw * sdUb ) .$$

$$ric 3 = 0.5 * cic 3 / ( sdiw * sdUc ) .$$

A flow A64: correlation coefficients rwa3, rwb3, and rwc3 of the wind electricity generation quantity with respect to the electricity consumption of the special level, the residential level, and the industrial and commercial levels are calculated respectively.

$$rwa 3 = 0.5 * cwa 3 / ( sdvww * sdUa ) .$$

$$rwb 3 = 0.5 * cwb 3 / ( sdvww * sdUb ) .$$

$$rwc 3 = 0.5 * cwc 3 / ( sdvww * sdUc ) .$$

A flow A65: a correlation coefficient ri4 of the photovoltaic electricity generation quantity with respect to the stored electricity quantity is calculated, where ri4=0.5*ci4/(sdiw*sds).

A correlation coefficient rw4 of the wind electricity generation quantity with respect to the stored electricity quantity is calculated, where rw4=0.5*cw4/(sdww*sds).

A flow A7: the data processing module calculates regression coefficients in the historical data sets respectively.

A flow A71: a regression coefficient bi1 of the illumination intensity with respect to the photovoltaic active power is calculated, where bi1=ri1*(sduip/sdi).

A regression coefficient bw1 of the wind speed with respect to the wind active power is calculated, where bw1=rw1*(sdww/sduwp).

A flow A72: a regression coefficient bi2 of the photovoltaic active power with respect to the photovoltaic electricity generation quantity is calculated, where bi2=ri2*(sdiw/sduip).

A regression coefficient bw2 of the wind active power with respect to the wind electricity generation quantity is calculated, where bw2=rw2*(sdww/sduwp).

A flow A73: regression coefficients bia3, bib3, and bic3 of the photovoltaic electricity generation quantity with respect to the electricity consumption of the special level, the residential level, and the industrial and commercial levels are calculated respectively.

$$bia 3 = 0.5 * ria 3 * ( sdUa / sdiw ) .$$

$$b ib 3 = 0.5 * rib 3 * ( sdUb / sdiw ) .$$

$$bic 3 = 0.5 * ric 3 * ( sdUc / sdiw ) .$$

A flow A74: regression coefficients bwa3, bwb3, and bwc3 of the wind electricity generation quantity with respect to the electricity consumption of the special level, the residential level, and the industrial and commercial levels are calculated respectively.

$$bwa 3 = 0.5 * rwa 3 * ( s dUa / sdww ) .$$

$$b wb 3 = 0.5 * rwb 3 * ( s dUb / sdww ) .$$

$$bwc 3 = 0.5 * rwc 3 * ( s dUc / sdww ) .$$

A flow A75: a regression coefficient bi4 of the photovoltaic electricity generation quantity with respect to the stored electricity quantity is calculated, where bi4=0.5*ri4*(sds/sdiw).

A regression coefficient bw4 of the wind electricity generation quantity with respect to the stored electricity quantity is calculated, where bw4=0.5*bw4*(sds/sdww).

A flow A8: the data processing module calculates correction coefficients in the historical data sets respectively to obtain regression equations.

A flow A81: a correction coefficient ai1 of the illumination intensity with respect to the photovoltaic active power is calculated, where ai1=Δuip−bi1*Δi; and a regression equation of the illumination intensity with respect to photovoltaic active power is y=bi1*x+ai1, where y represents the photovoltaic active power, and x represents the illumination intensity.

A correction coefficient aw1 of the wind speed with respect to the wind active power is calculated, where aw1=Δuwp−bw1*Δw; and a regression equation of the illumination intensity with respect to the photovoltaic active power is y=bw1*x+aw1, where y represents wind active power, and x represents the wind speed.

A flow A82: a correction coefficient ai2 of the photovoltaic active power with respect to the photovoltaic electricity generation quantity is calculated, where ai2=Δiw−bi2*Δuip; and a regression equation of the photovoltaic active power with respect to the photovoltaic electricity generation quantity is y=bi2*x+ai2, where y represents the photovoltaic electricity generation quantity, and x represents the photovoltaic active power.

A correction coefficient aw2 of the wind active power with respect to the wind electricity generation quantity is calculated, where bw2=rw2*(sdww/sduwp), and aw2=Δww−bi2*Δuwp; and a regression equation of the photovoltaic active power with respect to the photovoltaic electricity generation quantity is y=bw2*x+aw2, where y represents the wind electricity generation quantity, and x represents the wind active power.

A flow A83: correction coefficients aia3, aib3, and aic3 of the photovoltaic electricity generation quantity with respect to the electricity consumption of the special level, the residential level, and the industrial and commercial levels are calculated respectively.

aia3=ΔUa−bia3*Δiw; and a regression equation of the photovoltaic electricity generation quantity with respect to the electricity consumption of the special level is y=bia3*x+aia3, where y represents the electricity consumption quantity of the special level, and x represents the photovoltaic electricity generation quantity.

aib3=ΔUb−bib3*Δiw; and a regression equation of the photovoltaic electricity generation quantity with respect to the electricity consumption of the residential level is y=bib3*x+aib3, where y represents the electricity consumption quantity of the residential level, and x represents the photovoltaic electricity generation quantity.

aic3=ΔUc−bic3*Δiw; and a regression equation of the photovoltaic electricity generation quantity with respect to the electricity consumption of the industrial and commercial levels is y=bic3*x+aic3, where y represents the electricity consumption quantity of the industrial and commercial levels, and x represents the photovoltaic electricity generation quantity.

A flow A84: correction coefficients awa3, bwb3, and bwc3 of the wind electricity generation quantity with respect to the electricity consumption of the special level, the residential level, and the industrial and commercial levels are calculated respectively.

awa3=ΔUa−bwa3*Δww; and a regression equation of the wind electricity generation quantity with respect to the electricity consumption of the special level is y=bwa3*x+awa3, where y represents the electricity consumption quantity of the special level, and x represents the wind electricity generation quantity.

awb3=ΔUb−bwb3*Δww; and a regression equation of the wind electricity generation quantity with respect to the electricity consumption of the residential level is y=bwb3*x+awb3, where y represents the electricity consumption quantity of the residential level, and x represents the wind electricity generation quantity.

awc3=ΔUc−bwc3*Δww; and a regression equation of the wind electricity generation quantity with respect to the electricity consumption of the industrial and commercial levels is y=bwc3*x+awc3, where y represents the electricity consumption quantity of the industrial and commercial levels, and x represents the wind electricity generation quantity.

A flow A85: a correction coefficient ai4 of the photovoltaic electricity generation quantity with respect to the stored electricity quantity is calculated, where ai4=Δs−bi4*Δiw; and a regression equation of the photovoltaic electricity generation quantity with respect to the stored electricity quantity is y=bi4*x+ai4, where y represents the stored electricity quantity, and x represents the photovoltaic electricity generation quantity.

A correction coefficient aw4 of the wind electricity generation quantity with respect to the stored electricity quantity is calculated, where aw4=Δs−bw4*Δww; and a regression equation of the wind electricity generation quantity with respect to the stored electricity quantity is y=bi4*x+ai4, where y represents the stored electricity quantity, and x represents the wind electricity generation quantity.

A flow A9: estimated electric energy data is calculated.

A flow A91: the data processing module substitutes the parameters in the flow A1 into the regression equations in the flow A8, and sequentially estimates an active power and an electricity generation quantity of the photovoltaic electricity generation station to obtain muip and miw; an active power and an electricity generation quantity of the wind electricity generation station are estimated to obtain muwp and mww; if the estimated photovoltaic electricity generation quantity is for electricity supply for the special level, the residential level, and the industrial and commercial levels, mUai, mUbi, and mUci are obtained; if the estimated wind electricity generation quantity is for electricity supply for the special level, the residential level, and the industrial and commercial levels, mUaw, mUbw, and mUcw are obtained; and a stored electricity quantity msi of the photovoltaic electricity generation quantity, and a stored electricity quantity msw of the wind electricity generation quantity are estimated.

A flow A92: the data processing module sends the estimated results in the data flow A91 to a primary electricity supply adjustment module as estimated electric energy data.

S3: adjusting electric energy supply of the electricity generation stations, the urban area, and the electricity storage devices according to the estimated electric energy data, and monitoring the electricity consumption data of the different levels of the urban area after being adjusted to obtain secondary electricity consumption data through the primary electricity supply adjustment module.

Furthermore, a flow B1: the primary electricity supply adjustment module records the photovoltaic reactive power in the power supply data as nip, and records the wind reactive power as nwp.

The electricity consumption quantity of the special level in the electricity consumption data is recorded as Ua, the electricity consumption quantity of the residential level is recorded as Ub, and the electricity consumption quantity of the industrial and commercial levels is recorded as Uc.

Device types in the energy storage data are read, and the stored electric quantities are recorded as s.

A flow B2: the primary electricity supply adjustment module compares the stored electric quantities.

A flow B21: if s≥(msi+msw), it indicates that an energy supply relationship of the region does not need to be adjusted, and subsequent steps of the flow B21 are not executed; if s<(msi+msw), it indicates that an electric power demand of the region is increased, s−(Ua+Ub+Uc) is calculated, and a flow B22 is executed.

The flow B22: if s−(Ua+Ub+Uc)>0, it indicates that the energy supply relationship of the region does not need to be adjusted; if s−(Ua+Ub+Uc)<0, it indicates that electric power needs to be supplemented additionally for the region, and subsequent steps of the flow B22 are not executed; and if s−(Ua+Ub+Uc)=0, it indicates that the electric power demand of the region is increased, and steps B3 and B4 are executed.

A flow B3: the primary electricity supply adjustment module compares a useful power and adjusts the electricity generation stations.

A flow B4: the primary electricity supply adjustment module compares useful electricity data and adjusts electric power distribution.

A flow B5: after the electric energy supply adjustment for the electricity generation stations, the urban area, and the electricity storage devices is completed in the flow B1 to the flow B4 above, the primary electricity supply adjustment module obtains the electricity consumption data of the different levels of the region again, and records the electricity consumption data as Uaa, Ubb, and Ucc.

A flow B6: the primary electricity supply adjustment module calculates secondary electricity consumption data ΔUU, where ΔUU=(mUi+mUw)−(Uaa+Ubb+Ucc).

A flow B7: the primary electricity supply adjustment module sends the secondary electricity consumption data to a secondary electricity supply adjustment module.

Furthermore,

A subsequent working flow of the flow B3 is as follows:
a flow B31: the primary electricity supply adjustment module compares uip with muip, and compares uwp with muwp; if uip≥muip and uwp≥muwp, it indicates that energy supply of the electricity generation stations is normal, and subsequent steps of the flow B31 are not executed; if uip<muip, it indicates that the photovoltaic electricity generation station needs to be adjusted, and a flow B32 is executed; and if uwp<muwp, it indicates that the wind electricity generation station needs to be adjusted, and a flow B33 is executed.

The flow B32: the primary electricity supply adjustment module adjusts the photovoltaic electricity generation station.

A flow B321: the primary electricity supply adjustment module reads current system time.

A flow B322: the primary electricity supply adjustment module obtains position information of the electricity generation station through being associated with the photovoltaic electricity generation station.

A flow B323: the primary electricity supply adjustment module obtains illumination time of the photovoltaic electricity generation station according to the position information, and judges whether the system time is within an illumination time period or not; if not, it indicates that the photovoltaic electricity generation station cannot be adjusted, and subsequent steps of the flow B323 are not executed; and if so, it indicates that the photovoltaic electricity generation station may be adjusted, and a flow B324 is executed.

The flow B324: the system time is recorded as t, and starting time and ending time of the illumination time period are recorded as AT1 and AT2 respectively.

A flow B325: an adjustment angle α for an electricity generation panel in the photovoltaic electricity generation station is calculated, where α=90−(t−AT1)/(AT2−AT1)*180.

The flow B325: the primary electricity supply adjustment module reads the maximum photoelectric inversion coefficient in a data base, and records the maximum photoelectric inversion coefficient as xia.

A flow B326: the primary electricity supply adjustment module is associated with a photoelectric inverter to obtain a current photoelectric coefficient, and records the current photoelectric coefficient as xi.

A flow B327: the primary electricity supply adjustment module calculates a photoelectric coefficient adjustment value Δxi, where Δxi=(1+nip/uip)*xi.

A flow B328: the primary electricity supply adjustment module judges whether Δxi is less than xia or not, if Δxi≤xia, an angle of the electricity generation panel in the photovoltaic electricity generation station is adjusted to be α, and the photoelectric coefficient of the photovoltaic inverter is adjusted to be Δxi; and if Δxi>xia, the angle of the electricity generation panel in the photovoltaic electricity generation station is adjusted to be α, and the photoelectric coefficient of the photovoltaic inverter is adjusted to be xia.

The flow B33: the primary electricity supply adjustment module adjusts the wind electricity generation station.

A flow B331: the primary electricity supply adjustment module reads the maximum wind electricity inversion coefficient in the data base, and records the maximum wind electricity inversion coefficient as xwa.

A flow B332: the primary electricity supply adjustment module is associated with a wind electricity inverter to obtain a current wind electricity coefficient, and records the current wind electricity coefficient as xw.

A flow B333: the primary electricity supply adjustment module calculates a wind electricity coefficient adjustment value Δxw, where Δxw=(1+nwp/uwp)*xw.

A flow B334: the primary electricity supply adjustment module judges whether Δxw is less than xwa or not, if Δxw≤xwa, the photovoltaic coefficient of the wind electricity inverter is adjusted to be Δxi; and if Δxw>xwa, the photovoltaic coefficient of the wind electricity inverter is adjusted to be xia.

A subsequent working flow of the flow B4 is as follows:
a flow B41: the primary electricity supply adjustment module calculates a photovoltaic electricity consumption quantity mUi=mUai+mUbi+mUci, and calculates a wind electricity consumption quantity mUw=mUaw+mUbw+mUcw.

A flow B42: the primary electricity supply adjustment module compares mUi+mUw with Ua+Ub+Uc. If mUi+mUw>Ua+Ub+Uc, it indicates that electricity supply for the region is sufficient, the primary electricity supply adjustment module reads the maximum stored electricity quantity in the data base according to the device types and records the maximum stored electricity quantity as ss, and a flow B43 is executed; and if mUi+mUw<Ua+Ub+Uc, it indicates that electric power distribution for the region is unreasonable, and a flow B44 is executed.

The flow B43: the primary electricity supply adjustment module calculates a storable electricity quantity Δs, where Δs=(mUi+mUw)−(Ua+Ub+Uc); whether s+Δs is less than ss or not is judged, if s+Δs≤ss, there is no additional electric energy for being distributed to other regions in the region; and if s+Δs≤ss, there is additional electric energy for being distributed to the other regions in the region, where the additional electric energy is hs, and hs=(s+Δs)−ss.

The flow B44: the primary electricity supply adjustment module adjusts electric power distribution.

A flow B441: the primary electricity supply adjustment module judges whether a ratio of mUai/mUaw is greater than 1 or not, if the ratio is greater than 1, it indicates that the energy supply of the wind electricity generation station is insufficient, and the flow B33 is executed; if the ratio is less than 1, it indicates that the energy supply of the photovoltaic electricity generation station is insufficient, and the flow B32 is executed; and if the ratio is equal to 1, whether a ratio of mUbi/mUbw is greater than 1 or not is compared, and the process enters a flow B442.

The flow B442: if mUbi/mUbw is greater than 1, it indicates that the energy supply of the wind electricity generation station is insufficient, and the flow B33 is executed; if mUbi/mUbw is less than 1, it indicates that the energy supply of the photovoltaic electricity generation station is insufficient, and the flow B32 is executed; and if mUbi/mUbw is equal to 1, whether a ratio of mUci/mUcw is greater than 1 or not is compared, and the process enters a flow B443.

The flow B443: if mUci/mUcw is greater than 1, it indicates that the energy supply of the wind electricity generation station is insufficient, and the flow B33 is executed; if mUci/mUcw is less than 1, it indicates that the energy supply of the photovoltaic electricity generation station is insufficient, and the flow B32 is executed; and if mUci/mUcw is equal to 1, it indicates that the electric energy supply for the region is insufficient, and electric power needs to be supplemented additionally.

S4: calling the electricity storage devices in surrounding regions according to the secondary electricity consumption data to supplement electric energy through a secondary electricity supply adjustment module.

A working flow of the secondary electricity supply adjustment module is as follows:

the secondary electricity supply adjustment module judges whether the secondary electricity consumption data ΔUU is greater than 0 or not; if ΔUU≥0, it indicates that electric energy supply balance for the region is realized, and additional supplementation is not needed; and if ΔUU<0, it indicates that electric power needs to be supplemented additionally for the region from the electricity storage devices in surrounding regions, so that an electric quantity of |ΔUU| is supplemented.

### Embodiment 2

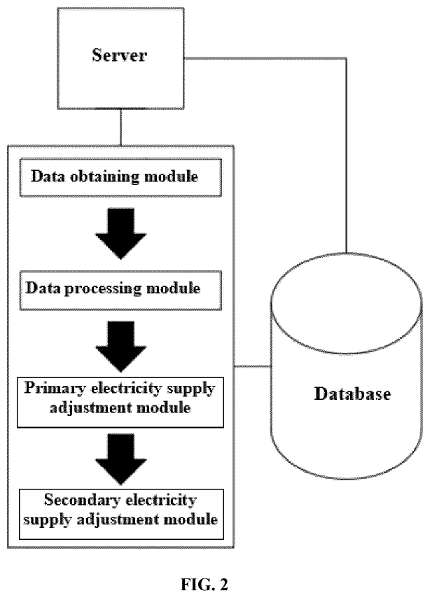

Referring to FIG. 2, an example of the present invention is proposed, and provides a system adopting the hierarchical and graded source-network-load-storage multi-subject collaborative scheduling method, and the hierarchical and graded source-network-load-storage multi-subject collaborative scheduling system includes a data obtaining module, a data processing module, a primary electricity supply adjustment module, a secondary electricity supply adjustment module, and a database module.

The data obtaining module is used for obtaining environment data, power data, and electricity generation data of electricity generation stations to obtain power supply data, obtaining electricity consumption data corresponding to different levels of an urban area, and obtaining energy storage data of electricity storage devices.

The data processing module is used for obtaining historical data sets of the electricity generation stations, the urban area, and the electricity storage devices, and analyzing the power supply data, the electricity consumption data, and the energy storage data according to the historical data sets to obtain estimated electric energy data.

The primary electricity supply adjustment module is used for adjusting electric energy supply of the electricity generation stations, the urban area, and the electricity storage devices according to the estimated electric energy data, and monitoring the electricity consumption data of the different levels of the urban area after being adjusted to obtain secondary electricity consumption data.

The secondary electricity supply adjustment module is used for calling the electricity storage devices in surrounding regions according to the secondary electricity consumption data to supplement electric energy.

The database module is used for storing historical average data of the electricity generation stations, the urban area, and the electricity storage device, historical average data of an environment, illumination time periods of different regions, the maximum stored electricity quantity of the different electricity storage devices, the maximum photoelectric inversion coefficient, and the maximum wind electricity inversion coefficient.

If a function is realized in the form of a software function unit and sold or used as an independent product, the function may be stored in a computer-readable storage medium. On the basis of this understanding, the technical solution of the present invention essentially or a part that contributes to the prior art, or a part of the technical solution may be embodied in the form of a software product, and the computer software product is stored in a storage medium and includes a plurality of instructions which are used for enabling a computer device (which may be a personal computer, a server, or a network device, etc.) to execute all or a part of the steps of the methods described in the various examples of the present invention. The above storage medium includes: various media that may store program codes, such as a USB flash drive, a mobile hard disk, a read-only memory (ROM), a random access memory (RAM), a magnetic disk, or an optical disc.

Logics and/or steps expressed in the flow diagram or otherwise described herein, for example, may be considered as an ordered list of executable instructions used for realizing logical functions, and may be specifically realized in any computer-readable medium for being used by instruction execution systems, apparatuses, or devices (such as computer-based systems, systems including processors, or other systems that may acquire instructions from the instruction execution systems, the apparatuses, or the devices and execute the instructions), or used in conjunction with these instruction execution systems, apparatuses, or devices. With regard to the present specification, the “computer-readable medium” may be any apparatus that may contain, store, communicate, propagate or transmit a program for being used by the instruction execution systems, the apparatuses, or the devices, or used in conjunction with these instruction execution systems, apparatuses, or devices.

More specific instances of the machine-readable storage medium (non-exhaustive list) include: an electric connection part (an electronic apparatus) with one or more wires, a portable computer disk case (a magnetic apparatus), a random access memory (RAM), a read-only memory (ROM), an erasable programmable read-only memory (EPROM or a flash memory), an optical fiber apparatus, and a portable compact disk read-only memory (CDROM). In addition, the computer-readable medium may even be paper or other appropriate media in which the program may be printed, due to that the program may be obtained in an electronic manner, for example, through optically scanning the paper or the other media, and then editing, interpreting or processing in other appropriate manners if necessary, and then the program is stored in a computer memory.

It should be understood that, each part of the present invention may be realized by hardware, software, firmware or a combination thereof. In the above implementation manners, a plurality of steps or methods may be realized by software or firmware stored in the memory and executed by the appropriate instruction execution systems. For example, if the plurality of steps or methods are realized by hardware, as in another implementation manner, the plurality of steps or methods may be realized by any one of the following technologies which are well known in the art or a combination thereof: a discrete logic circuit with a logic gate circuit for realizing a logic function for a data signal, an application-specific integrated circuit with an appropriate combinational logic gate circuit, a programmable gate array (PGA), a field-programmable gate array (FPGA), etc.

### Embodiment 3

In the example, in order to verify the beneficial effects of the present invention, scientific demonstration is carried out through economic benefit calculation and simulation experiments. In order to verify the effectiveness and superiority of the “hierarchical and graded source-network-load-storage multi-subject collaborative scheduling method” of the present invention, a series of theoretical experiments is designed, and a scientific demonstration is carried out through comparing and analyzing the method with traditional technical solutions for electric energy scheduling. According to the present invention, electric energy supply and demand can be more accurately predicted and adjusted through comprehensively utilizing the historical data and real-time multi-source data, and realizing hierarchical and graded dynamic scheduling, and especially in the aspect of dealing with volatility and randomness of renewable energy such as wind electricity and photovoltaics, significant advantages are shown.

A traditional electric energy scheduling method (hereinafter referred to as a traditional method) is mainly based on static supply and demand prediction, and single resource optimization, and lacks the capability of comprehensively analyzing historical data and multi-source data. In the traditional method, the electric energy scheduling usually relies on a simple historical average demand for prediction, and a scheduling decision mainly relies on real-time supply and demand situations, without considering the volatility of environment data and diversified resources, so that a scheduling response is often delayed while facing renewable energy access and complex load changes, and it is difficult to effectively utilize distributed power sources and energy storage devices.

Table 1 shows comparison results between the method and the traditional method.

TABLE 1
Comparison result

| | | | The method of |
|---|---|---|---|
| Evaluation | | Traditional | the present |
| indicator | Indicator | method | invention |
| Prediction | Prediction | 82% | 95% |
| accuracy test | accuracy rate | | |
| Scheduling | Response time | 45 | 30 |
| response speed | | | |
| test | | | |
| Utilization | Energy storage | 68% | 85% |
| efficiency test | utilization rate | | |
| for energy storage | | | |
| devices | | | |
| Utilization rate | Wind electricity | 72% | 88% |
| test for renewable | utilization rate | | |
| energy | | | |
| Utilization rate | Photovoltaic | 75% | 90% |
| test for renewable | utilization rate | | |
| energy | | | |

A prediction accuracy test: according to the method of the present invention, the accuracy rate of electric energy demand prediction is significantly increased through comprehensively utilizing the historical data and the real-time multi-source data, and increased from 82% in the traditional method to 95%, and due to the improvement, the electric energy scheduling is more accurate, so that scheduling errors and unnecessary energy waste are effectively reduced.

A scheduling response speed test: in the case of a sudden change in demand, according to the method of the present invention, scheduling response time is reduced from 45 seconds in the traditional method to 30 seconds, so that the response speed of scheduling is increased, which is of great significance for rapidly balancing supply and demand of a power grid, and improving system stability.

A utilization efficiency test for the energy storage devices: according to the present invention, through hierarchical and graded scheduling and precise prediction, a utilization rate for the energy storage devices is increased from 68% to 85%, which indicates that according to method, the energy storage devices can be more effectively managed and utilized, and peak shaving capability and flexibility of the power grid are enhanced.

A utilization rate test for renewable energy: according to the method of the present invention, there is a significant increase in utilization rates for wind electricity generation and photovoltaic electricity generation, the wind electricity utilization rate is increased from 72% to 88%, and the photovoltaic utilization rate is increased from 75% to 90%. This result indicates that, the method can better adapt to the volatility of the renewable energy, optimize the access and utilization of the renewable energy, and promote wider application of green energy.

It should be noted that, the above examples are merely used for illustrating the technical solution of the present invention and are not for limitation, although the present invention is described in detail with reference to the preferred examples, those of ordinary skill in the art should understand that, the technical solutions of the present invention may be modified or equivalently substituted without departing from the spirit and scope of the technical solution of the present invention, and all those modifications or replacements should be included in the scope of the claims of the present invention.

What is claimed is:

1. A hierarchical and graded source-network-load-storage multi-subject collaborative scheduling method, comprising:
obtaining environment data, power data, and electricity generation data of electricity generation stations to obtain power supply data, obtaining electricity consumption data corresponding to different levels of an urban area, and obtaining energy storage data of electricity storage devices through a data obtaining module;
obtaining historical data sets of the electricity generation stations, the urban area, and the electricity storage devices, and analyzing the power supply data, the electricity consumption data, and the energy storage data according to the historical data sets to obtain estimated electric energy data through a data processing module;
adjusting electric energy supply of the electricity generation stations, the urban area, and the electricity storage devices according to the estimated electric energy data, and monitoring the electricity consumption data of the different levels of the urban area after being adjusted to obtain secondary electricity consumption data through a primary electricity supply adjustment module; and
calling the electricity storage devices in surrounding regions according to the secondary electricity consumption data to supplement electric energy through a secondary electricity supply adjustment module.

2. The hierarchical and graded source-network-load-storage multi-subject collaborative scheduling method according to claim 1, wherein the obtaining power supply data comprises that a data obtaining module is associated with illumination sensors and photovoltaic electricity generation devices of a photovoltaic electricity generation station to obtain illumination intensity, a photovoltaic electricity generation quantity, a photovoltaic active power, and a photovoltaic reactive power of the photovoltaic electricity generation station;
the data obtaining module is associated with wind speed sensors and wind electricity generation devices of a wind electricity generation station to obtain a wind speed, a wind electricity generation quantity, a wind active power, and a wind reactive power of the wind electricity generation station;
the data obtaining module is associated with a power grid of the urban area to obtain an electricity consumption quantity of a special level, an electricity consumption quantity of a residential level, and an electricity consumption quantity of industrial and commercial levels, so as to obtain electricity consumption data;
the data obtaining module is associated with electricity storage devices to obtain device types and stored electric quantities of the electricity storage devices, so as to obtain energy storage data;
the data obtaining module takes the illumination intensity and the wind speed as environment data, takes the wind active power, the wind reactive power, the photovoltaic active power, and the photovoltaic reactive power as power data, takes the wind electricity generation quantity and the photovoltaic electricity generation quantity as electricity generation data, and takes the environment data, the power data and the electricity generation data as power supply data; and
the data obtaining module sends the power supply data, the electricity consumption data, and the energy storage data to the data processing module.

3. The hierarchical and graded source-network-load-storage multi-subject collaborative scheduling method according to claim 2, wherein the obtaining historical data sets of the electricity generation stations, the urban area, and the electricity storage devices comprises that the data processing module obtains historical average data of the electricity generation stations, the urban area, and the electricity storage devices in the past three years, and historical average data of an environment through a database, so as to obtain historical data sets;
average values of the historical data sets are calculated respectively, variances of the historical data sets are calculated respectively after the average values are evaluated, standard deviations of the historical data sets are calculated respectively after the variances are evaluated, and covariances of the historical data sets are calculated respectively after the standard deviations are evaluated through the data processing module.

4. The hierarchical and graded source-network-load-storage multi-subject collaborative scheduling method according to claim 3, wherein the obtaining estimated electric energy data comprises that correlation coefficients in the historical data sets are calculated respectively, regression coefficients in the historical data sets are calculated respectively after the correlation coefficients are evaluated, correction coefficients in the historical data sets are calculated respectively after the regression coefficients are evaluated to obtain regression equations, and estimated electric energy data is calculated after the regression equations are obtained through the data processing module, and the estimated electric energy data is sent to a primary electricity supply adjustment module through the data processing module after the estimated electric energy data is obtained.

5. The hierarchical and graded source-network-load-storage multi-subject collaborative scheduling method according to claim 4, wherein the adjusting electric energy supply of the electricity generation stations, the urban area, and the electricity storage devices comprises that the primary electricity supply adjustment module records the photovoltaic reactive power in the power supply data as nip, and records the wind reactive power as nwp;
the electricity consumption quantity of the special level in the electricity consumption data is recorded as Ua, the electricity consumption quantity of the residential level is recorded as Ub, and the electricity consumption quantity of the industrial and commercial levels is recorded as Uc;
device types in the energy storage data are read, and the stored electric quantities are recorded as s; and
comparing the stored electric quantities through the primary electricity supply adjustment module comprises that if s≥(msi+msw), it indicates that an energy supply relationship does not need to be adjusted, if s<(msi+msw), it indicates that an electric power demand is increased, when s<(msi+msw), if s−(Ua+Ub+Uc)>0, it indicates that the energy supply relationship does not need to be adjusted, if s−(Ua+Ub+Uc)<0, it indicates that electric power needs to be supplemented additionally, if s−(Ua+Ub+Uc)=0, it indicates that, the electric power demand is increased, and when s−(Ua+Ub+Uc)=0, the primary electricity supply adjustment module compares a useful power and adjusts the electricity generation stations, and the primary electricity supply adjustment module compares useful electricity data and adjusts electric power distribution;
wherein msi represents the stored electric quantity of an estimated photovoltaic electricity generation quantity, msw represents the stored electric quantity of the wind electricity generation quantity, Ua represents the electricity consumption quantity of the special level in the electricity consumption data, Ub represents the electricity consumption quantity of the residential level, and Uc represents the electricity consumption quantity of the industrial and commercial levels.

6. The hierarchical and graded source-network-load-storage multi-subject collaborative scheduling method according to claim 5, wherein the obtaining secondary electricity consumption data comprises that after the electric energy supply adjustment for the electricity generation stations, the urban area, and the electricity storage devices is completed, the primary electricity supply adjustment module obtains the electricity consumption data of the different levels again, and records the electricity consumption data as Uaa, Ubb, and Ucc;
the calculating secondary electricity consumption data through the primary electricity supply adjustment module is represented as
$$Δ UU = ( mUi ) - mUw ) - ( Uaa + Ubb + Ucc )$$
wherein mUi represents the estimated photovoltaic electricity generation quantity, and mUw represents an estimated wind electricity generation quantity; and
the primary electricity supply adjustment module sends the secondary electricity consumption data to a secondary electricity supply adjustment module.

7. The hierarchical and graded source-network-load-storage multi-subject collaborative scheduling method according to claim 6, wherein the calling the electricity storage devices in surrounding regions to supplement electric energy comprises that whether the secondary electricity consumption data ΔUU is greater than 0 or not is judged through the secondary electricity supply adjustment module, if ΔUU≥0, it indicates that electric energy supply is balanced, and if ΔUU<0, it indicates that electric power needs to be supplemented additionally from the electricity storage devices in surrounding regions, so that an electric quantity of |ΔUU| is supplemented.

8. A system adopting the hierarchical and graded source-network-load-storage multi-subject collaborative scheduling method according to claim 1, comprising a data obtaining module, a data processing module, a primary electricity supply adjustment module, a secondary electricity supply adjustment module, and a database module, wherein
the data obtaining module is used for obtaining environment data, power data, and electricity generation data of electricity generation stations to obtain power supply data, obtaining electricity consumption data corresponding to different levels of an urban area, and obtaining energy storage data of electricity storage devices;
the data processing module is used for obtaining historical data sets of the electricity generation stations, the urban area, and the electricity storage devices, and analyzing the power supply data, the electricity consumption data, and the energy storage data according to the historical data sets to obtain estimated electric energy data;
the primary electricity supply adjustment module is used for adjusting electric energy supply of the electricity generation stations, the urban area, and the electricity storage devices according to the estimated electric energy data, and monitoring the electricity consumption data of the different levels of the urban area after being adjusted to obtain secondary electricity consumption data;
the secondary electricity supply adjustment module is used for calling the electricity storage devices in surrounding regions according to the secondary electricity consumption data to supplement electric energy; and
the database module is used for storing historical average data of the electricity generation stations, the urban area, and the electricity storage device, historical average data of an environment, illumination time periods of different regions, the maximum stored electricity quantity of the different electricity storage devices, the maximum photoelectric inversion coefficient, and the maximum wind electricity inversion coefficient.

9. A computer device, comprising a memory and a processor, wherein the memory stores a computer program, and when the processor executes the computer program, the steps of the hierarchical and graded source-network-load-storage multi-subject collaborative scheduling method according to claim 1 are realized.

10. A computer-readable storage medium in which a computer program is stored, wherein when the computer program is executed by a processor, the steps of the hierarchical and graded source-network-load-storage multi-subject collaborative scheduling method according to claim 1 are realized.
